(19) United States
(12) Patent Application Publication
(10) Pub. No.: US 2005/0129228 A1
(43) Pub. Date: Jun. 16, 2005

(54) Modular computerized encryption scheme

(76) Inventor: Victor Justin LaGarde, Keller, TX (US)

Correspondence Address: Justin LaGarde, 8628 Shadow Trace Dr., Keller, TX, 76248, US

(21) Appl. No.: 10/733,527

(22) Filed: Dec. 12, 2003

(51) Int. Cl. H04L 9/00

(52) U.S. Cl. 380/42

(57) ABSTRACT

This paper introduces a design of a series of six modular computerized ciphers which can be performed sequentially and in a number of rounds, to form an encryption scheme greater than the sum of its parts.

### CROSS-REFERENCE TO RELATED APPLICATIONS

Not Applicable

### STATEMENT REGARDING FEDERALLY SPONSORED RESEARCH OR DEVELOPMENT

Not Applicable

### REFERENCE TO SEQUENCE LISTING, A TABLE, OR A COMPUTER PROGRAM LISTING COMPACT DISK APPENDIX

Not Applicable

### BACKGROUND OF THE INVENTION

This invention pertains to the field of cryptography/other (Classification 380/59). Over the years and centuries, numerous classical cryptography methods have proven to be vulnerable to attack, by frequency analysis or other methods. With the advent and popularization of the personal computer and computerized spreadsheet in the early to mid 1980's, it became possible to design and implement computerized ciphers and encryptions. Furthermore, these computer programs can be designed to be modular, in that the output of one can be fed into the input of another, further increasing the complexity of the encryption. This modularization is the primary claim of this patent. A search of patents with the words “modular” and “encryption” in the title was made, back to 1976 (before the advent of personal computer hardware and software utilized in the creation of this invention). No similar claims were found.

### BRIEF SUMMARY

The encryption scheme is modular in that the output of one computerized encryption may be fed into the input of another, and a sequential series of encryptions formed. To facilitate this modularization, each module has an input and output of identical size, an 100 row by 80 column block of text (approximately two single-spaced pages of text).

Additionally, the same module could be used repeatedly, but with its working parameters modified each time. Provisions for this are made by externalizing key parameters in data files accessible to the user. This concept was utilized for Modules 2 thru 6 and could be applied to the design of Module 1 as well.

A brief Description of Each Module Follows:

Module 1: A modified Vigenere cipher, of 10 randomized alphabets, with a 18 digit key which determines which substitution alphabets are used. An alphabet of 36 characters, 26 lower case letters and 10 numer, was used.
Module 2: A Hill cipher, using a 10×10 matrix multiplied upon a 10×1 vector (a 10 character sub-block).
Module 3: A “shifting” cipher to shift and intermix rows and columns of the input text block (100 row by 80 columns). Module 3 can be described as a block function operating on a relatively large (100×80) block of text (a “super block”).
Module 4: A poly-alphabetic substitution cipher similar to Module 1 except there are 80 substitution alphabets, one for each column of text to be encrypted. Each alphabet is not randomized as in Module 1 but is determined by a linear equation ax+b where “a” is a four digit number prime with regard to 36, the length of the alphabet. The “prime” stipulation helps eliminate degenerate alphabets.
Module 5: A poly-alphabetic substitution cipher, where there are 36 randomized alphabets and a key text equal in size to the input text, the key text determining which substitution alphabets are used, and in what order.
Module 6: “Noise” is added modulo 36 to the input text, as an encryption, then removed as a decryption.

### BRIEF DESCRIPTION OF THE SEVERAL VIEWS OF THE DRAWING

Not Applicable

### DETAILED DESCRIPTION OF THE INVENTION

A Detailed Description of Each Module is Given Below:

Module 1:

The input text is contained in a file “input.daf”, being a text file 100 rows by 80 columns. An alphabet of 26 lower case letters and 10 numerals (total of 36 characters) is used within (inside) this module as well as the others. Here, in this module alone, there are no limitations on characters used in the input file, but for ease of construct, the capital letters are later reduced to lower case letters, and punctuation, blanks and other symbols are allowed to pass through the program unencrypted.

A work-around, or kluge, for Microsoft Fortan only, perhaps: Let the computer read “input dat” one line at a time in a format “A80”, then write to an internal memory (buffer) as format “A80” but then retrieve from the buffer (read from it) in a format “80A1”. This can convert a single line of “input.dat” into a row of an array, with 80 elements. Useful.

A spreadsheet table is made of some number (10 here) of scrambled or randomized alphabets, for reference. This look-up table is implemented within the computer program's code by a series of callable Fortran subroutines, each one implementing one substitution alphabet by means of a series of 36 Fortran “if . . . then” statements. One example of such a statement might be similar to: if (letter.eq.‘a’) then letter=‘z’. The output text is contained in a file “output.dat”.

A companion computer program is made to decrypt “output.dat” into a new output file “dcrypt.dat”. This program simply has the characters in the “if . . . then” statements reversed.

A user-input 18 digit key, also using the same 36-character alphabet, is used to specify which substitution alphabets are used, and in what order. For example, a key “ac” might be interpreted as “use alphabet 1 (a=1) to look up a substitution for the first character to be encrypted, alphabet 3 (c=3) for the second character, etc. An 18 digit key was selected as a maximum length easily memorized. If this key were an easily memorized phrase, composed of four smaller words (of length four or five characters), there are approximately 16×10\hat{ }12 possibilities (there being, in round numbers, 2000 common four-letter words and 2000 common five-letter words). One example of this type of 18 digit key is “looselipssinkships”. Of course, the introduction of numerals and words not in the dictionary (proper names, place names, foreign words, etc.) increases the number of possible keys, e.g. “ubereigen2506henri”, “babar9802sanssouci”, “eulergammaquidvici”, etc. In this module, two randomly chosen alphabets are added to the 18 character key as padding, since the resulting effective total key length 20 divides evenly into 80, the number of columns of text to be enciphered (the key is used four times per row of input text).

This module could be improved by adding more substitution alphabets or a longer key. Another improvement would be to not embed the substitution alphabets in Fortran “if . . . then” statements, but to arrange them in a data file which the computer program could read into a data array of 36 rows, each column being one substitution alphabet. This would give the user access to the data file, with the ability to modify the operations of the module externally.

Module 2:

The input text is of the same size and name as in Module 1, but there is a restriction that all characters must be lower case letters or numerals (no blanks or punctuation are permitted due to ensuing operations). Padding characters may be used to fill the input text block. Initially each character of the input text is converted to a numerical value 0 thru 35, in a one-to-one correspondence, through a single scrambled or randomized substitution alphabet implemented by “if . . . then” blocks. These values are then taken ten at a time and transformed by an enciphering matrix (10×10) into new values, using matrix multiplication, then later converted back to the familiar 36-character alphabet and released as output. The deciphering process is identical but uses a companion matrix, a deciphering matrix which is the inverse of the enciphering matrix. Both the enciphering and deciphering matrices are supplied to the computer program as data files (changeable should the need arise).

A spreadsheet is used to calculate the 10×10 inverse matrix, the matrix which undoes the encryption. (A spreadsheet solving for the inverse of a 5×5 matrix was performed as an intermediate exercise.) Further spreadsheets are used to calculate the determinate of a 10×10 matrix and a 9×9 matrix (necessary for computing the inverse of the 10×10 matrix). The spreadsheets solving for the inverse matrix incorporate modulo 36 arithmetic not found in ordinary matrix calculators found on the internet. A spreadsheet modeling the computation of an inverse of a 3×3 matrix is the first step.

Module 3:

The same input and output files are used. The input text is inducted into an array. A data file contains instructions for shifting and intermixing the columns of this array. An example of this file might be 0380 which would be interpreted as move column 3 to column 1, move column 80 to column 2, etc. This file is also inducted into a separate array, which can be simply manipulated internal to the program to produce a decoding array. A similar arrangement is made for shifting and intermixing the rows of the input text

Provisions are made for the user to select an encryption or decryption mode of the program, which results in “input.dat” being encrypted to “output.dat”, or “output.dat” being decrypted to “dcrypt.dat”, respectively. Both row and column enciphering arrays are supplied to the computer program as data files (readily changeable if necessary).

Module 4:

Using a spreadsheet, a column of integers 0 thru 35 is formed. In the next column a linear equation y=(ax+b) mod 36 transforms the first column, where “a” is a four digit integer prime with respect to 36, “b” a small prime such as 5 or 7, and “x” the integer in the first column to be transformed. Using an internet factorization applet and this spreadsheet, eighty suitable integers are discovered and evaluated for forming substitution alphabets, one for each column of text to be encoded. (Integers forming degenerate alphabets, without a one-to-one correspondence (or mapping) from x to y are discarded).

These suitable integers are then placed in a file for access by the program (where they are easily changeable should it be desired). The computer program accepts these 80 integers, uses the equation to generate a substitution alphabet for each integer, and stores the alphabets in a 36 row by 80 column array, each column being an alphabet. This array is used as a substitution table for the text to be encrypted. Again, a simple manipulation of the 36×80 encrypting array results in a decrypting array, and the user is given an option to either encrypt or decrypt, using the same program.

Module 5:

An alphabetic substitution table is imported into the program as a 36 row×36 column array, each column being one alphabet of 26 alpha and 10 numer characters. An input text, “input.dat”, comprised of a message embedded within an 100 row by 80 column padded text, is formed as usual. A “key text”, ideally of random, evenly distributed characters, of identical size to “input.dat”, is chosen (here the key text was selected from excerpts of the classical texts of Vegetius, Beowulf, and Cicero). All three texts (alphabets, input, and key) are modifiable by the user, external to the computer program, for maximum flexibility. The encryption uses the alphabet table to find the substitution for the inputs of a given key (selects the column of the alphabet table) and a given plaintext character (selects the row of the alphabet table). The decryption first locates the cipher letter in the table, then looks up the input coordinates using the key, to arrive at the original plain text character.

Module 6:

A “noise” text is added modulo 36 to the input text. The noise text is the same as the “key text” of Module 5, and is modifiable by the user. The decryption is the opposite, the subtraction of the noise (key) from the encrypted text. In this module, conversion of the characters “a” thru “z” and “0” thru “9” into the integers “0” thru “35” is required, through a Fortran “if . . . then” sequence, as performed elsewhere.

Appendix—Examples of Input and Output Data Files.

An example of the data file ‘input.dat’ follows. This block has a background (filling or padding) composed from excerpts from the classical texts, Caesar's “Commentaries” and Sun Tzu's “The Art of War”. A short “secret” message is embedded at row 23, but any message up to a size 100 rows by 80 columns can be enciphered here.

allgaulisdividedintothreepartsoneofwhichthebelgaeinhabittheaquitanianotherxthose
whointheirownlanguagearecalledceltsinourgaulsthethirdallthesedifferfromeachother
inlanguagecustomsandlawstherivergaronneseparatesthegaulsfromtheaquitanithemarnea
ndtheseineseparatethemfromthebelgaeofallthesethebelgaearethebravestbecausetheyar
efurthestfromthecivilizationandrefinementofourprovinceandmerchantsleastfrequentl
yresorttothemandimportthosethingswhichtendtoeffeminatethemindandtheyaretheneares
ttothegermanswhodwellbeyondtherhinewithwhomtheyarecontinuallywagingwarforwhichre
asonthehelvetiialsosurpasstherestofthegaulsinvalorastheycontendwiththegermarisina
lmostdailybattleswhentheyeitherrepelthemfromtheirownterritoriesorthemselveswagew
arontheirfrontiersonepartofthesewhichithasbeensaidthatthegaulsoccupytakesitsbegi
nningattheriverrhoneitisboundedbytherivergaronnetheoceanandtheterritoriesofthebe
lgaeitborderstooonthesideofthesequaniandthehelvetiiupontheriverrhineandstretches
towardthenorththebelgaerisesfromtheextremefrontierofgaulextendtothelowerpartofth
eriverrhineandlooktowardthenorthandtherisingsunaquitaniaextendsfromtherivergaron
netothepyrenaearmiountainsandtothatpartoftheoceanwhichisnearspainitlooksbetweenth
esettingofthesunandthenorthstarchapter2axnongthehelvetiiorgetorixwasbyfarthemostd
istinguishedandwealthyxhewhenmarcusmessalaandmarcuspisowereconsulsincitedbylusto
fsovereigntyformedaconspiracyamongthenobilityandpersuadedthepeopletogoforthfromt
heirterritorieswithalltheirpossessionssayirigthatitwouldbeveryeasysincetheyexcell
edallinvalortoacquirethesupremacyofthewholeofgaultothishethemoreeasilypersuadedt
hembecausethehelvetiiareconfinedoneverysidebythenatureoftheirsituationononesideb
ytherhineaverybroadanddeepriverwhichseparatesthehelvetianterritoryfromthegermans
hellothisiszimmermanjoinusandyoucanhavearizonanewmexicoandtexasoveronasecondside
bythejuraaveryhigbmountainwhichissituatedbetweenthesequaniandthehelvetiionathird
bythelakeofgenevaandbytheriverrhonewhichseparatesourprovincefromthehelvetiifromt
hesecircumstancesitresultedthattheycouldrangelesswidelyandcouldlesseasilymakewar
upontheirneighborsforwhichreasorunenfondofwarastheywerewereaffectedwithgreatregre
ttheythoughtthatconsideringtheextentoftheirpopulationandtheirrenownforwarfareand
braverytheyhadbutnarrowlimitsalthoughtheyextendedinlength240andinbreadth180roman
mileschapter3inducedbytheseconsiderationsandinfluencedbytheauthorityoforgetorixt
heydeterminedtoprovidesuchthingsaswerenecessaryfortheirexpeditiontobuyupasgreata
numberaspossibleofbeastsofburdenandwagonstomaketheirsowingsaslargeaspossiblesoth
atontheirmarchplentyofcornmightbeinstoreandtoestablishpeaceandfriendshipwiththen
eighboringstatestheyreckonedthatatermoftwoyearswouldbesufficientforthemtoexecute
theirdesignstheyfixbydecreetheirdepartureforthethirdyearorgetorixischosentocompl
etethesearrangementshetookuponhimselftheofficeofambassadortothestatesonthisjourn
eyhepersuadescasticusthesonofcatamantaledesoneofthesequaniwhosefatherhadpossesse
dthesovereigntyamongthepeopleforxnanyyearsandhadbeenstyledfriendbythesenateofther
omanpeopletoseizeuponthesovereigntyinhisownstatewhicbhisfatherhadheldbeforehiman
dhelikewisepersuadesduinnorixanaeduanthebrotherofdivitiacuswhoatthattimepossessed
thechiefauthorityinthestateandwasexceedinglybelovedbythepeopletoattemptthesamean
dgiveshimhisdaughterinmarriageheprovestothemthattoaccomplishtheirattexnptswasathi
ngveryeasytobedonebecausehehimselfwouldobtainthegovernmentofhisownstatethatthere
wasnodoubtthatthehelvetiiwerethemostpowerfulofthewholeofgaulheassuresthemthathew
illwithhisownforcesandhisownarmyacquirethesovereigntyforthemincitedbythisspeecht
heygiveapledgeandoathtooneanotherandhopethatwhentheyhaveseizedthesovereigntythey
willbymeansofthethreemostpowerfulandvaliantnationsbeenabledtoobtainpossessionoft
hewholeofgaulchapter4whenthisschemewasdisclosedtothehelvetiibyinformerstheyaccor
dingtotheircustomcompelledorgetorixtopleadhiscauseinchainsitwasthelawthatthepena
ltyofbeingburnedbyfireshouldawaithimifcondemnedonthedayappointedforthepleadingof
hiscauseorgetorixdrewtogetherfromallquarterstothecourtallhisvassalstothenumberof
tenthousandpersonsandledtogethertothesameplaceallhisdependentsanddebtorbondsmeno
fwhomhehadagreatnumberbymeansofthoseherescuedhimselffromthenecessityofpleadinghi
scausewhilethestateincensedatthisactwasendeavoringtoassertitsrightbyarmsandthema
gistratesweremusteringalargebodyofmenfromthecountryorgetorixdiedandthereisnotwan
tingasuspicionasthehelvetiithinkofhishavingcommittedsuicidechapter5afterhisdeath
thehelvetiineverthelessattempttodothatwhichtheyhadresolvedonnamelytogoforthfromt
heirterritorieswhentheythoughtthattheywereatlengthpreparedforthisundertakingthey
setfiretoalltheirtownsinnumberabouttwelvetotheirvillagesaboutfourhundredandtothe
privatedwellingsthatremainedtheyburnupallthecornexceptwhattheyintendtocarrywitht
hemthatafterdestroyingthehopeofareturnhometheymightbethemorereadyforundergoingal
ldangerstheyordereveryonetocarryforthfromhomeforhimselfprovisionsforthreemonthsr
eadygroundtheypersuadetherauraciandthetulingiandthelatobrigitheirneighborstoadop
tthesaxneplanandafterburningdowntheirtownsandvillagestosetoutwiththemandtheyadmit
totheirpartyandunitetothemselvesasconfederatestheboiiwhohaddweltontheothersideof
therhineandhadcrossedoverintothenoricanterritoryandassauitednoreiachapter6therew
ereinall tworoutesbywhichtheycouldgoforthfromtheircountryonethroughthesequaninarr
owanddifficultbetweenmountjuraandtheriverrhonebywhichscarcelyonewagonatatimecoul
dbeledtherewasmoreoveraveryhighmountainoverhangingsóthataveryfewmighteasilyinter
ceptthemtheotherthroughourprovincemucheasierandfréerfromobstaclesbecausetherhone
flowsbetweentheboundariesofthehelvetiiandthoseoftheallobrogeswhohadlatelybeensub
duedandisinsomeplacescrossedbyafordthefurthesttownoftheallobrogesandthenearestto
theterritoriesofthehelvetiiisgenevafromthistownabridgeextendstothehelvetiitheyth
oughtthattheyshouldeitherpersuadetheallobrogesbecausetheydidnotseemasyetwellaffe
ctedtowardtheromanpeopleorcompelthembyforcetoallowthemtopassthroughtheirterritor
ieshavingprovidedeverythingfortheexpeditiontheyappointadayonwhichtheyshouldallme
etonthebankoftherhonethisdaywasthefifthbeforethekalendsofaprilthe28thofmarchinth
econsuishipofluciuspisoandaulusgabiniusbc5echapter7whenitwasreportedtocaesarthat
theywereattemptingtomaketheirroutethroughourprovincehehastenstosetoutfromthecity
andbyasgreatmarchesashecanproceedstofurthergaulandarrivesatgenevaheordersthewhol
eprovincetofurnishasgreatanumberofsoldiersaspossibleastherewasinallonlyonelegion
infurthergaulheordersthebridgeatgenevatobebrokendownwhenthehelvetiiareapprizedof
hisarrivaltheysendtohimasambassadorsthemostillustriousmenoftheirstateinwhichemba
ssynumeiusandverudoctiusheldthechiefplacetosaythatitwastheirintentiontomarchthro
ughtheprovincewithoutdoinganyharmbecausetheyhadaccordingtotheirownrepresentation
snootherroutethattheyrequestedtheymightbeallowedtodosowithhisconsentcaesarinasmu
chashekeptinremembrancethatluciuscassiustheconsulhadbeenslainandhisarmyroutedand
madetopassundertheyokebythehelvetiididnotthinkthattheirrequestoughttobegrantedno
rwasheofopinionthatmenofhostiledispositionifanopportunityofmarchingthroughthepro
vinceweregiventhemwouldabstainfromoutrageandntischiefyetinorderthataperiodmightin
terveneuntilthesoldierswhomhehadorderedtobefurnishedshouldassembleherepliedtothe
ambassadorsthathewouldtaketimetodeliberateiftheywantedanythingtheymightreturnont
hedaybeforetheidesofaprilallwarfareisbasedondeceptionhenceawisegeneralmakesapoin
tofforagingontheenemyhewinshisbattlebymakinqnomistakesinbattletherearenotmoretha
ntwomethodsofattackthedirectandtheindirectyetthesetwoincombinationgiverisetoanen
dlessseriesofmaneuversletyourplansbedarkandimpenetrableasnightandwhenyoumovefall
likeathunderboltponderanddeliberatebeforeyoumakeamovethisiscalledabilitytoaccomp
lishathingbysheercunningwhenthesefivekindsofspyareallatworknonecandiscoverthesec
retsystemthisiscalleddivinemanipulationofthethreadsitisthesovereignsmostprecious
facultyhenceitisonlytheenlightenedrulerandwisegeneralwhowillusethehighestintelli

After transformation by the sequence [module 2+module 3+module 4], the resulting encrypted data file ‘output.dat’ is shown below (it is fully recoverable by applying the decryption sequence [module 4+module 3+module 2]).

pbjo5gb4pthy6zksnj8l6l5ghkwfen06tii0251phg1uozwfn3o2cglee6so218081dyglitrm4icrjl
ru5hc8dkr868iqxs1t1nf2hzglpzjli1avuj4p8jjmn3qudgpiv3y056oqc9ogosdiu4x0qmvmyjxljw
qikchri7hrdxhmjjz2kw1forywo9uoyqniw80qo9rk56z9kcxjfaow9om4f4d6cunfj6gzyw5myblb7z
0i29x3b21pjz37ppjq4w2ejjg5fgholgy7qngore1hz7bqe6c5tnvo2cn3imf16jj2rgmtrx3z2w5sjb
aoolo706041dnjprvxpzby13wv1terbfuccbvx8t2yrd0rbs0buthc1zrmao11hqz53zzqjilk7w2qrj
44jhzapap5schr2dee54gpxs3vwvcs61s1w6w5yggf3dgm6dkvwx2mcpgatnora9nwdsoppc1n41inp9
4gyvu0keq51keojdho7uli7eyv75esgleyaaff72cy3366pselv0asukqedotda4b3lan5x10f1j2vdx
be3b84rmdjrpj3394r1u0mjk9rff10czmqwtp7y9ye7ui51o5v15q74egahvr1ffb4z4wwcwg160ecbu
g62ub9at9jd8111iccsw9fuz659gfw5gf5ejg141kh3ohmyfpc8s5nkpc1cc3pa596aq0s7cgi1oplxl
c9q6wkc2f4a8whm4nuap9kz6fyumthwdnzva25ip96r8vvjy00bcmiyf5uca6fc7e0teadv5mzzu99fp
qwmvqpvotkpfsazivz9tedciu1jzm8c6u883g0fgpegmu6jirjxbv6vxikz0r1fbc21ksz1304f608kk
6crmokakn6gsmr0nhibr8laudoxfvttwhvjgkx8d67xh74wra30ojdf6ayt6ketwzi22avzvy033vqaq
yawewndqrjtlnz82bqw8776wu8o9314fqkdow628i3nwqq72so3omz28qpeqak1kkll5o9oixe2p7kku
1fshqriev45347rcb7c3s6fh7nj7vx9q5i3n6858ohhiswqf9r5vpw6s8wv98qvfra0ab0ae68bimo1v
4nm26r1ps1sil9f52v3u180vxoacua4svcr0q58we6aq5wjqpdwdk79mglh113681d88jq6urq79daod
qpr6y9y27k9fjjyijfr0y6iy3v6umv09ppk204hszpt8aq18f15g1vi1e5bn0uj8kkhb6713a871mmyx
fx54t5tb6x1mvhkdbrcud1ywdwbmed81u4gwindz7ycalex51z23a153wwmqq94wq0sljuhuuh96685j
zdzevkxz34w9b1fql6702g21oyuncv8z3b1lx1cnbci5ab9orswzinlbs6ucbg96bf1gv5q6cw5v9icf
pbo5xl6mf0brhaw8ou6031qywb6gvpfc2soodl9sth0w61qn93p319zwitpexfu9fonbgwnc6x97dubz
ilzseh7yqpdibi39811y0o7ptcsaxbg7scapa7wiv9euyim2tqgvhsaxa76w70vznkz1wkza2noxqxgs
63d5qodsr8361ljnutv9g6v76cg931ts5yeboflirhmn2t9hys776d340efig3h5de608l96bgc2pj1z
9iemv99blfs11de5wh9oscad3o6ehpef8n4hijxno6e1oshn9cixs0q31ivxu1zq3m476gcchye93ibg
k16ny67c3280l9v5nsj2jvghfhf888skyhgairrl6o808ut2dtawqjt80bnjdxlo21ou3rsu7onmvnnp
jg0hp6i3rryvwu6e417p2muh6x4p7ae9xphf8nqzd5adrpwovn2rb9s6299fnupflm5c4i0t2b7dilin
x49a9xpxj4m9nb1q3nvbz8ro26mofujf87653vtp7tqzvydllei5fmxkyyfuh9ss626ojprm5mgerdpq
kx3v05rrj3j6m6aypjbs4qc0dsl5q0bu3mnbhkrnybgl9avh2rk2bkow4t27gc28ypeptnexuw1493kk
3vocq4bdhp2t9cvahk371cpzpt6vch0v0gb407ohzijg3j71f90ala8m5uofv4j5nvzdharlbz23sf17
jf5lx0swb0q6b9xstsj4apb8jg0vhxq0ma6pfdtrbp21jziuwrjm2chkw7girnvi2z1jprvw9y6qmbqv
ez55k4oru2ve7qdra6jpiawg71w8ouy2h5byvavqlm7z2ikfol6y43mv73k15fqqzpii511lo6kz87kb
d5hpar4ugxuy20wsxgvnvwpoe1bt6gq777f23h4hidq836vci7ugoo4maxi6l1zkgzpldgylbwe0rfxh
90xrxw3ch6vyzbpsurg5zngqyet409mi78tkiw4x8at1het5n2fgmticyeaflwdr8v4ewgdgcr7v2fky
0i9trcb15clc6xp7vlc6mljiua619viwrinyxfqxcswdz276iejqhtj9u9t7c20a244856cj0fvl6wm0
ew1nxps98avw8vbx3euplphjcjt006sy9xutld63bu3iyl76hmaj45x7xecfyd7khgek3rsv35a9uve6
oubojmklzvnanhnwqkqrw0tt0il29vjcevq8kpdu2rdztjemtpsc0koxdw7umkafcyk22wvetcylgao9
0msgcrqdk432m5skwudje9mt0h3tfhhilbnc58136tg1zye550jiu66w5v2ipevns16gerbc42q1ivb5
z84fsnwlfddgld6zq5kjf8wjqhwbfuev3igknz6vz3wolk8ebii8e9hxpwpgaa7nfjl063soywj2h58h
15yp3hysnkdudx3il70woz291py92yssrls2uxqlhtp385p2pj1517zj97ah176q6b68syxrk5gdjh1g
p9mp64b7mbx5gh04y53x76e5ucymowgw2cbmnd878e53rgmjtej1ktcuqoozdr7rifrp7wce58ls0xi5
ruwjyztmsys3ld9aimrrj00c767qii6yzk65g9zvf58jwhp5jsrhq2i1rpxbe68ovbpxwvauuz2d25k8
lrwg05p2z455vjufflmfsbnjl9x49amuxfssu3i4m1bgohpeuczute57naododyjdrwvv6vdl4aasv7g
9xu4rqj6kzpo5676qbq2vnq678roqo31svtt91x6y4y23tmlgibi1u464sbw19s1d31hdkt5k9oo65x7
p2uv3cg7vilugoefx8lmn9vbptpafptm06onktq9qylrhrx9vx3d12u4apxndpdbswv2si41qwu761n3
vjp5a7uh61autorco8uyfswrhm3of1f2clnglaomuyno2x25r4910sqahcljnu0xysg5r688usvyygol
5ty70hz1mkizyhvbi7g53ixsbsf69xilnfg0y1g3n4m749or0hc8pgj3spvrv4kjj2e7871p1pvib91k
arjidud3dk1w6vndlpbtd6v6pcrgljkurz1whtrb4k10t2mma88f342tdmzde3kcbzu0a27mq5ec4qhz
07mgufmzv5roqtlebsyos1tbqfuwolw459o4qrmucz7g0zczley7xcd8cpgibnyrms4rkb0xa1y8z9mx
kz3ah9h3nsx533yrdm7uzdfe4crwyblzw4dkrc0rpp2vz18m4w8ya7fe4yyffs2y530fgj00845mmwh7
g2xe3rdn1udhhfyu45v2q4m2g5s0urhvm9pabpu00dc5mxxxwg30qhvbw1gs66ifgfvlmes2emuto9up
2uca6zm87f4g51nks9xzuinbasq3nuqhen1aok3g90fmmnj6pj2u6p92t68yxw41rl3w5hseli13d2qw
0brhqj8yanzrzlltupha2b7bxnugmttw7e66dqajzx4fcnpoelrq6apsrht909ejk09wppynpy50i3jo
983kcmitwerf4pxu72s3984ha2v1j1peo8qazjg36ppzlhnna0gi9kxnztzi4rv789hg6gezswlny1kr
101c9360uk83a7hj2h0i0xstc8tq6fds4zjifbd00xohadveza7p7qmfg8kuxtsk034r06sajdc6ggxb
bgkjjsf6175ccv3qqrawkvvoq8b8o4zupjhopcw1p2yggz059t6wrmpf52x74jtvnntsyta0171i1b5e
88v2eaaj56dehmwki3s6gq38ev06q06peffckzmgafc7ys8n6qtr5p3qpca3ovwr8n9golzynkn7ose1
5svded5asmh02fa22tkzqbh56ayxz1ifqoooizkr7625bak9cazib1odv1uobtjnhop2m2f7bpwtc10j
rzyki5bew92yy9060gj18wyit2oj2wcowy04g1amdfuzzcmu5g5dv14lbax4ye4z6vo2qjjw9622pa3i
51q8u25ga5li1up2pbkuuz4jm6dumi2y69m2g4ph0cjodct5yeyobu8e5d5hm4tzpko4jy4s7dttgrp1
rnxdpbltxngadsq4eblivcbg1vwjnx7u5q26wd0effzqa3qppswigqejj3e7ghkrtngax3fy91glqkig
fvtefa9a29jsihg2q8ahgatzfonoiporcidhh9j38zmb3fmkburpc1htoydmwe5paz768x47dinkvi01
7ew10hb5t9i67fzaftjcg4ukzvhdo0o9ttiijm3w23ero6ydzxoxggsk4p0rgodckem9zetzffxbmoap
16woy5w2uenhlcz513ynthun3gezqb2uolqmoc65ytg4u9dulrbiposungj1o2v7hrt6st55bff2kix8
isj80e0cfvi3meblgkzed5p55x7w31fp131syyv0ys5h228tagm52jtcsxz50i59gldjhzq1o9z96me0
jxloha26kk55b0jvrj01apj9ndlwawyuqp3nn573alt35iebo2hj1h83adu64mixi8qnnvyb739thefe
olldkarj11xr415188dvnlukx1vh43kuwqe26o5vynsfnvz3mtwxok1feruusmk6slcfkpfezkwkxeti
nugt0drx99tx94ak0enamp5dh52jm3kbpqxs6ihx7ep9u807s35tqz46mb1grvz18ainq33xsk5m0s15
kq2erqam0tfyed9srmq677o9agclof4crpu8op033f95j272x3c7m2oorxka94bt013p4yssmua5xcnb
pbg5sm14yn46ywz2zmwuoaezeczqjgppt77wzxuglljbdggpgh620gdtrrru8so9wz5m8thokvh1hbxi
1ffu3f7ekn6q0ps5fg73avu63t07p66b6111iscpxdmxdvphlm8amooqfyi58qkkl9es3j9gxnlg2iau
yf9ttornpzlce4loob0t75h9q2vtbbqh4qspz70tz7j9jkry88w1pph2drwabeuonm80ba6d50iukgzc
a5c3sjy2xxp8vted0vysqpiljgxae515ni58xsi5avic8t0z0qs079e8vsnbhkpi5guh067wzjzr3uzs
4fpas8pchvxkaog8x0wn9ssqked4he7h516lxjfm17nxj7gw60mlfq6aik54jkpjcdj5bu1uubx2fd5g
3ksk0d9a7co0yovx7hy78c14453y68waiv2zoioxmdm2hdv2kg1n24olyh3ggtih17k2wqbzphg8l8df
p9yvxsb6hxv821gttzz4piro92q2nkvx4pv7ms0gqd7z8i5jg5jhqeddp4yissmdpmo1nnij1btbnv87
ikxjefivnd2bdb26fv3bpwb0q3k8ixe42hhzsrwtaan62ixclup3grewki4y0myc2b128fk3lso1ez92
y8ow3cuhmv9145bfppxja230nb8n1vjcpb2zvzgmej4h1cxzq07v4avnvn54qp6b9d5zgimvo31gg08x
y39vnkss5aookmcmuzawqlwf6k7c9bsfu3r6g1we9tzlce4wtklk3pe6dv6bgre8awm821rhlqky9jwx
545hyqbnhwa6azp73euhldpb9a4ceyew8ev18lnohb6avenhzr1mlzwjtaxl1fe16jcgfa7mud463w5x
wwtzkvvng4p5m5h4hlfa0ywn6lxwln1go0y79ik2por23s7ng4x352vnnvq01rt6wgqrn3a9j3fdm1gw
7oibwvis7vey570jlh2whx5b043fki81dxpf892tukozo9x3b457n0dx5818ihcezk0sfbyz18yzjvkr
1pw1397af9qb8vw0o7x28uo21kqnfi5yvvolvxes1whkyd8ie92ybtvhf270y1h4lez6nwat6navspjn
c2z27gs93h2hliru6wd1ewrwndt1em97elg2hfde19kt5ecdfklc6eiu9o1nxulmfcf1zo12sbkpgqtc
rr0mnezzm5z7j6klia6yh2ovst0d2p95qa03ldyh6zyfbtgvyp1oqf3yjjs48yn6tzih5qeljhablp8u
yj5os7rcgza8w7bth19g08b4h2vn7zifj3nplbvtl4i6fc9fzc0iyfpksjg4ilhr75v6cfwdjmvxzc42
3rq9bx6s5gz3vab114a5o2wdrdk7nt1musouhw3czest2z2o602ojs4mgcn0mrmqw0f7sq548amgba21
y8hqos8jktcoazdm26fy8d3zfccc1bu9pis20gix2q7x9w4e3g05bb7gli18hh4942ekewbt8zoq407z
vbahzjehdta6gv3sfe6vlpbm7y141bjyvg62odcefq1ecss8isz67q4892adj8dhyzla3568xzvm1jc1
8zmvpw436atgujqjrwkba3p0yzj04i8vy4j0i52zigxynnn5wi234o06u37sswbnv0nrpsb5jbos4pch
oi678uobnnka0xxla10b1uc43am9bq8z0g6vy8txin2rc4b8i7q5o4v7elmawuc9y05ymap9bssk2a4p
edv4r89g98fdm579ryhzqs6awap5eshsdscc1ie1rvhdk23gncnwrp7t920oj5cb73y6wi7nnkkx354q
s1ywzo68n5bmyr7z89okdkssb3xo28n9ya21syh0y4uv08dvrcwoy525xvf974gecu5op1vq5q4y9ecu
1lz7cf4h2azovk6h2xitoyhb8stfuf1bmpynra54c5voje8yugg9awbqvsffayowgx0ejsdtf84kw6a4
egmkh1ydo8lw6ky10jzm1h8buge79ts2ye7p17x1y3bar541083v16s8h0ohb3k12do3ccsnvc1ekghj
edsi2djnauenk5aor9spaowf4wduyku2ja8k8h34ovj3x9oowlrih40xsqcp4wtxyo4m5nkrqd59sg68
ogbaa8wzmz505ei3ninh0y17yzltghx53sp8xt4i3x051xu53glo1qmlc7mz47r7dktupmgkik2iy7gy
ez83cvrlg9j8e5ay6kvxh4h0mh9bphb2y28qj4ndp7c5s2j7q4yakzp3j070yuz7g628k6mvfgb3yl70
g1l8mcdm8jm98i487n66vnp048zsrhgrgpbkqfdrxpk40qgkyjhj2davmldr2j3a73y9xim2yalj65tm
tqjwzeohcwrabafmk769m8b0i94m5du1icpqe6c2yixa4vjsy84z2n1ql6lngmdrrt2d5lj0ag4f8s8p
im1lm0ye6nuqw4nyby7heuy73d371tmbkijgk9x3mkopxyimima2as9sfrrbhdcnv6qz3j1oonlmpsph
xz2mf0m37ric6msrge4uzzn6ifvgqqp9hp873eddo396aoevx6seks3z4yftvyl76xc99t7i4bqzx4ie

1. A modular computerized encryption scheme can be formed from the performance of a sequential series of computerized modules. Each module is a computerized encryption in its own right, said to be modular in that the output of one encryption can be fed into the input of another. The sequential performance of multiple modules, and permutations of modules, substantially increase the complexity and security of the overall encryption, leading to an encryption greater than the sum of its parts. This modularity constitutes claim one.

2. Each module has key operating parameters which are externalized to the computer program, and may be easily changed. Once these parameters are changed, the module may be used repeatedly, with completely different results each time, in effect a new module is created by altering data files external to the computer program. This permutability constitutes claim two.
